(19) United States
(12) Patent Application Publication
(10) Pub. No.: US 2025/0028876 A1
(43) Pub. Date: Jan. 23, 2025

(54) MULTI-LEVEL PREDICTIONS IN WORKFLOW LOGIC OF COMPUTER-AIDED DESIGN (CAD) APPLICATIONS

(71) Applicant: Siemens Industry Software Inc., Plano, TX (US)

(72) Inventors: James D. Linder, Franklin, TN (US); Janardan Gaikwad, Pune (IN)

(73) Assignee: Siemens Industry Software Inc., Plano, TX (US)

(21) Appl. No.: 18/708,918

(22) PCT Filed: Nov. 18, 2022
(86) PCT No.: PCT/US2022/050442

§ 371 Date: May 9, 2024

(30) Foreign Application Priority Data
Dec. 9, 2021 (IN) 202111057290

(51) Int. Cl. G06F 30/20; G06F 30/10; G06F 111/16; G06F 119/20

(52) U.S. Cl. CPC G06F 30/20; G06F 30/10; G06F 2111/16; G06F 2119/20

(57) ABSTRACT

A computing system may include a logic construction engine configured to construct, via multi-level prediction, workflow logic to process a computer-aided design (CAD) model. The logic construction engine may do so by identifying a multi-node sequence inserted into the workflow logic, aggregating past workflow data specific to the multi-node sequence, determining a node prediction in the workflow logic for the multi-node sequence based on the aggregated past workflow data, and providing the node prediction as a suggested insertion for the workflow logic.

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports multi-level predictions in workflow logic of CAD applications.

FIG. 2 shows an example construction of workflow logic via multi-level prediction.

FIG. 3 shows an example determination of a predicted multiple node sequence for workflow logic.

FIG. 4 shows an example determination of a node prediction that connects disjointed nodes inserted into workflow logic.

FIG. 5 shows an example of logic that a system may implement to support multi-level predictions in workflow logic of CAD applications.

FIG. 6 shows an example of a computing system that supports multi-level predictions in workflow logic of CAD applications.

### DETAILED DESCRIPTION

Modern CAD applications can support the design, management, and verification of products and product manufacturing processes of ever-increasing complexity. To support various types of processing capabilities, CAD applications may provide workflow logic that is designed to process, track, or control design objects, for example to manage a product at various stages of product design, validation, manufacture, or more. As used herein, workflow logic (also sometimes referred to as business logic or processing logic) may refer to any type of processing, execution sequence, function set, method, or procedure that an application performs for a digital object, such as a CAD model. Workflow logic may include, as examples, validation procedures, component lookups, security checks, assembly parameter extractions, equipment verifications, manufacturing checkpoints or criteria, or any other processing of CAD models and digital designs.

Workflow logic may be implemented to provide nearly any type of processing for digital designs. For instance, workflow logic can be designed such that 3D model information for CAD models can drive the authoring of product and manufacturing information (PMI) for the CAD models. As an illustrative example, workflow logic can be implemented such that machined holes within a certain dimension range (e.g., diameter between 0.15-0.85 centimeters) specifically in aluminum components of an object will be assigned a specified tolerance (e.g., a preconfigured tolerance of +/−0.001 centimeters). Thus, this workflow logic may process CAD models to generate and apply such tolerance PMI accordingly for any object components that specify the criteria set forth in this particular instance of workflow logic. The types of processing of CAD models that workflow logic can be designed to perform are near limitless.

As products and manufacturing processes continue to increase in design complexity, workflow logic designed to process such products may likewise becoming increasingly complex, especially as specific products may require customized or version-specific processing. CAD applications may provide various capabilities to create and edit workflow logic for CAD models, however manual design of such workflow logic can be cumbersome, time-consuming, and error prone. Moreover, within the context of specific design domains, it is not uncommon for the same or similar series of logic operations to be used repeatedly. Such patterns of repeating logic operations may exist in the context of the same workflow logic instance (e.g., designed to process a particular CAD model) or across multiple, distinct instances of workflow logic for multiple CAD models, products, product variants, manufacturing processes, and the like.

As used herein, elements of workflow logic may include nodes, connections, ports, or any combination thereof. A node may refer to an element of workflow logic, and may include specific processing operations, functions, or other actions to execute in the workflow logic. Nodes may include one or more input ports and one or more output ports to link to other nodes in workflow logic. A port may refer to receptors of a node for connections, and a connection may refer to a logical link between nodes of workflow logic. As such, workflow logic may be comprised of a collection of nodes and connections between the nodes, allowing a user to specify a customized sequence for processing CAD models. Repeating logic patterns in workflow logic may be in the form of specific sequences of nodes and connections that are repeated across a single or multiple instances of workflow logic.

Conventional CAD applications may lack the capability to enable a user designing workflow logic to reliably recreate sets of patterned logic operations based on past data for a current design context of workflow logic. In some instances, single-level prediction may be applied to determine a next single node for workflow logic, doing so based on a prior connection in the workflow logic. Such single-level prediction methods can be rudimentary, simplistic, and naive, failing to account for underlying sequences of connections in workflow logic. As such, accuracy may be a limiting factor in single-level prediction techniques. Node predictions may be vastly different when a broader context of workflow logic is considered. Moreover, single level node predictions in workflow logic can be cumbersome and inefficient, for example requiring a user to repeatedly predict a next node in the workflow logic over and over and continually select a single node prediction during workflow logic design. Such repetition of single-level node prediction may require repeated and sequential performance of prediction processes and user inputs, which may result in increased computing times and longer workflow logic design latencies all the while providing reduced prediction accuracy within a limited prediction context.

The disclosure herein may provide systems, methods, devices, and logic for multi-level predictions in workflow logic of CAD applications. The multi-level prediction technology described herein may address any number of limitations in conventional single-level predictions, for example by providing an ability to predict node sequences comprising multiple nodes for workflow logic. Through multi-connection and multi-node predictions, the present disclosure may increase the accuracy and efficiency of workflow logic design. Such multi-level predictions may reduce the amount of user interactions with a CAD application, providing reduced user inputs (e.g., mouse clicks, keyboard strokes) that can reduce computing resource consumption in CAD systems. By performing a multi-node prediction, the features of the present application need not perform prediction computations over and over for each individual node prediction, as with single-level predictions. As such, the computing resource requirements and computing latency of the described multi-level prediction technology may be reduced as compared to conventional techniques.

Additionally or alternatively, the multi-level prediction technology described herein may increase the accuracy of node predictions in workflow logic as compared to conventional techniques. By accounting for an increased context of node sequences inserted into workflow logic, compounded prediction probabilities across multiple node levels inserted into the workflow logic may provide for increased accuracy in predictions as compared to single-level context considerations. These and other features of the multi-level prediction technology and the technical benefits of the present disclosure are described in greater detail herein.

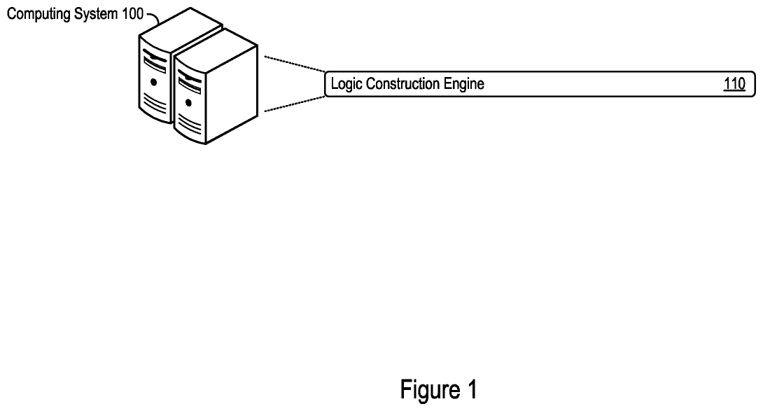

FIG. 1 shows an example of a computing system 100 that supports multi-level predictions in workflow logic of CAD applications. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements a CAD application that provides any combination of workflow logic generation capabilities. For example, the computing system 100 may implement or host a logic editor component of a CAD application that allows for the design, modification, and verification of any type of workflow logic configured to process any type of CAD object or other relevant digital design.

As an example implementation to support any combination of the multi-level prediction features described herein, the computing system 100 shown in FIG. 1 includes a logic construction engine 110. The computing system 100 may implement the logic construction engine 110 (including components thereof) in various ways, for example as hardware and programming. The programming for the logic construction engine 110 may take the form of processor-executable instructions stored on a non-transitory machine-readable storage medium and the hardware for the logic construction engine 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the logic construction engine 110 may construct, via multi-level prediction, workflow logic to process a CAD model. The logic construction engine 110 may do so by identifying a multi-node sequence inserted into the workflow logic, aggregating past workflow data specific to the multi-node sequence, determining a node prediction in the workflow logic for the multi-node sequence based on the aggregated past workflow data, and providing the node prediction as a suggested insertion for the workflow logic.

These and other multi-level prediction features and technical benefits according to the present disclosure are described in greater detail next.

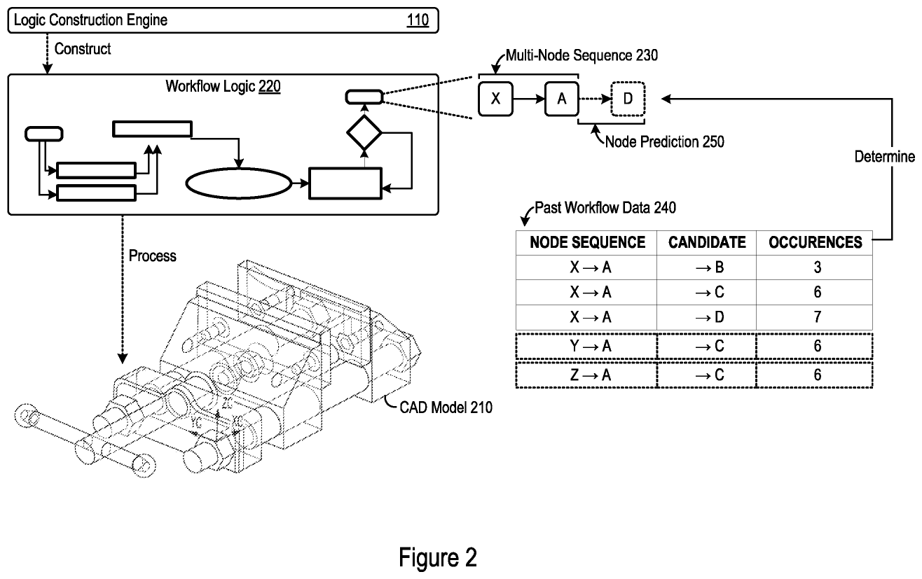

FIG. 2 shows an example construction of workflow logic via multi-level prediction. In the example shown in FIG. 2, the logic construction engine 110 constructs workflow logic to process CAD models, such as the CAD model 210 shown in FIG. 2. The CAD model 210 may be in the form of any digital object design, and the logic construction engine 110 may support the construction of any suitable workflow logic by which to process the CAD model 210. As an illustrative example, the logic construction engine 110 may support construction of the workflow logic 220 shown in FIG. 2, which may take the form of any suitable interconnected logic, functions, processes, or other set of actions to perform for the CAD model 210.

In constructing the workflow logic 220, the logic construction engine 110 may receive any number of user inputs which can drive the insertion and design of nodes, connections, ports, or any other relevant elements into the workflow logic 220. In that regard, the logic construction engine 110 may implement or otherwise be part of a logic editor capability provided by CAD applications. As part of such a CAD application, the logic construction engine 110 may provide, implement, or support any of the multi-level prediction features described herein. In particular, the logic construction engine 110 may determine node predictions for the workflow logic 220, doing so based on multi-node sequences inserted into the workflow logic 220. By determining node predictions based on multi-node sequences inserted into the workflow logic 220, the logic construction engine 110 may consider an expanded context within workflow logic as compared to single-node context predictions, which may thereby result in increased accuracy of node predictions.

In supporting multi-node predictions, the logic construction engine 110 may identify multi-node sequences inserted into the workflow logic 220. The degree, depth, or parameters by which the logic construction engine 110 identifies multi-node sequences within workflow logic may be configurable, e.g., via predetermined default values or user-specified requirements. For instance, in the logic construction engine 110 may be configured to identify multi-node sequences with a configured sequence depth (also understood as sequence length), such as a default sequence depth of two (2) nodes. As an illustrative example, the workflow logic 220 shown in FIG. 2 includes the multi-node sequence 230, which has a sequence depth of two nodes. In particular, the multi-node sequence 230 shown in FIG. 2 includes the two nodes “X” and “A” linked via a connection in the workflow logic 220. Thus, the logic construction engine 110 may identify the X→A multi-node sequence 230 within the workflow logic 220 for which to determine a node prediction.

To determine a node prediction for the multi-node sequence 230 (in this case, X→A), the logic construction engine 110 may aggregate past workflow data. Past workflow data may refer to data determined from any preexisting instance of workflow logic or sub-portion thereof, and the logic construction engine 110 may aggregate past workflow data specific to a particular multi-node sequence identified by the logic construction engine 110 for which to determine a node prediction. In aggregating past workflow specific to an identified multi-node sequence, the logic construction engine 110 may parse preexisting instances of workflow logic (which may include the workflow logic 220 itself) to identify any occurrences of the identified multi-node sequence as well as the subsequence node(s) in such identified occurrences. Put another way, the logic construction engine 110 may identify node sequences in preexisting instances of workflow data that include the identified multi-node sequence 230 as well as other surrounding (e.g., subsequent) nodes.

In the example of FIG. 2, the logic construction engine 110 aggregates the past workflow data 240, which may include identified occurrences of the X→A multi-node sequence in preexisting instances of workflow logic and a subsequent node in each identified occurrence. The subsequent node in identified occurrences of the X→A multi-node sequence are illustrated (as one example) by a candidate column and occurrence column in the past workflow data 240. In such an example, the logic construction engine 110 identifies three (3) occurrences of an X→A→B node sequence in preexisting instances of workflow logic, six (6) occurrences of an X→A→C node sequence, and seven (7) occurrences of an X→A→D sequence.

In some implementations, the logic construction engine 110 may identify port-specific occurrences of an identified multi-node sequence. That is, the past workflow data 240 aggregated by the logic construction engine 110 may track node sequence occurrences on a port-specific basis. For example, the X→A multi-node sequence 230 identified by the logic construction engine 110 in the workflow logic 220 may include a specific output port on node “X” and a specific input port on node “A” for the connection between nodes “X” and “A” in the workflow logic 220 (e.g., output port “2” in node “X” and input port “1” in node “A”). The logic construction engine 110 may aggregate the past workflow data 240 only for node sequence occurrences that match the specific output port on node “X” and the specific input port on node “A” for the X→A multi-node sequence 230. In a similar manner, the logic construction engine 110 may group occurrences of a subsequent node in a port-specific manner as well. In some sense, port-specific connections may be treated by the logic construction engine 110 as separate logical entities, and node prediction may be determined accordingly based on these separate entities.

Note that in aggregating the past workflow data 240, the logic construction engine 110 may access preexisting instances of workflow logic in various ways. For instance, the logic construction engine 110 may implement or otherwise access data repositories that store workflow logic instances designed or generated by a CAD application. Such repositories may be filtered or otherwise separated based on different partitioning criteria, and the logic construction engine 110 may support targeted aggregation of past workflow data based on any number of partitioning criteria.

As examples, the logic construction engine 110 may aggregate the past workflow data 240 that is user-specific, user role-specific, application client-specific, CAD model type-specific, or via any number of additional or alternative partitioning criteria. The logic construction engine 110 may thus filter a general set of past workflow data in order to parse or otherwise aggregate only specific occurrences of a multi-node sequence that satisfy the partitioning criteria. Various examples of such are described herein.

For user-specific past workflow data, the logic construction engine 110 may access preexisting instances of workflow logic, and filter the accessed instances specifically for past workflow data of a particular user (e.g., filter by user ID or any other identifier that uniquely identifies a user). In that regard, the logic construction engine 110 may identify (and aggregate into past workflow data 240) occurrences of a particular multi-node sequence included only within past workflow data of the particular user. In doing so, the logic construction engine 110 may ignore, not consider, or otherwise filter out past workflow data from other users, allowing for a user-specific node predictions.

As another example, the logic construction engine 110 may aggregate past workflow data that is specific to one or more user roles. For instance, the logic construction engine 110 may do so by filtering a repository of past workflow data based on a specific user role identifier (e.g., past workflow data authored or saved by an admin user role or a senior designer role). As yet another example, the logic construction engine 110 engine may aggregate application client-specific past workflow data. Multiple types, versions, or subcomponents of a CAD application may utilize workflow logic construction capabilities, and the logic construction engine 110 may filter past workflow data specifically based on application client ID's. Continuing the examples described herein, the logic construction engine 110 may filter past workflow data specifically for a particular CAD model type (e.g., circuit assemblies), which may refer to any delineator by which a CAD application groups, characterizes, or differentiates between different sets or types of CAD models.

In any such manner, the logic construction engine 110 may support customized aggregation of past workflow data 240 based on any such partitioning criteria. By doing so, the logic construction engine 110 may refine the specific context in which occurrences of a multi-node sequence are identified for node prediction determinations. Past workflow data 240 aggregated for a specific user, user-role, CAD model type, or application client may allow for increasingly targeted node predictions, specific to a given industry, user, or design style. Through such flexibility and customization, the multi-node predictions determined by the logic construction engine 110 may be increasingly specific and refined, allowing for increased accuracy and customization controlled according to the partitioning criteria. As such, the logic construction engine 110 may access past workflow data that comprises an identified multi-node sequence filter the past workflow data that comprises the multi-node sequence specifically for a particular user, a particular user role, a specific application client used to construct the workflow logic, a particular CAD model type, or any combination thereof.

From past workflow data aggregated specifically for a multi-node sequence, the logic construction engine 110 may determine a node prediction in the workflow logic for the multi-node sequence. In the example of FIG. 2, the logic construction engine 110 determines the node prediction 250 for the multi-node sequence 230 identified from workflow logic 220. The logic construction engine 110 may determine the node prediction 250 based on the past workflow data 240 aggregated specifically for the multi-node sequence 230, for example doing so based on the number of occurrences of the identified multi-node sequence and subsequent nodes in existing workflow logic (which may be filtered based on the partitioning criteria described herein). In that regard, the logic construction engine 110 may utilize any type of multi-tier Markov chain probability determinations in order to determine node predictions. In the example of FIG. 2, the logic construction engine 110 determines node “D” as the node prediction 250 for the X→A multi-node sequence 230, doing so based on the X→A→D sequence having a highest number of occurrences (and thus, a greatest Markov chain-based probability) in the past workflow data 240.

Note that the node prediction 250 determined by the logic construction engine 110 via identification of a multi-node sequence may differ from a node prediction determined via single node-level contexts. Such an example is illustrated in FIG. 2 in which other node sequences that end in node “A” within preexisting instances of workflow logic are shown. In considering only node “A” (e.g., single node context), past workflow data may include three (3) occurrences of an A→B node sequence, eighteen (18) occurrences of an A→C node sequence, and seven (7) occurrences of an A→D node sequence. In this case looking at a limited single-node context, single-level prediction techniques may generate a node prediction of node “C” in contrast to the node prediction 250 of node “D” in FIG. 2.

In this example, the node prediction 250 of node “D” generated via multi-level prediction may differ from the single-level context of conventional techniques. By utilizing multi-level contexts in workflow logic and multi-node sequence identifications, the multi-level prediction technology of the present disclosure may provide increased accuracy and increased predictive capability. This may be the case as multi-level predictions can be determined via an increased context in the workflow logic 220. The multi-level prediction technology described in the present application may thus provide increased predictive capabilities as compared to conventional technology.

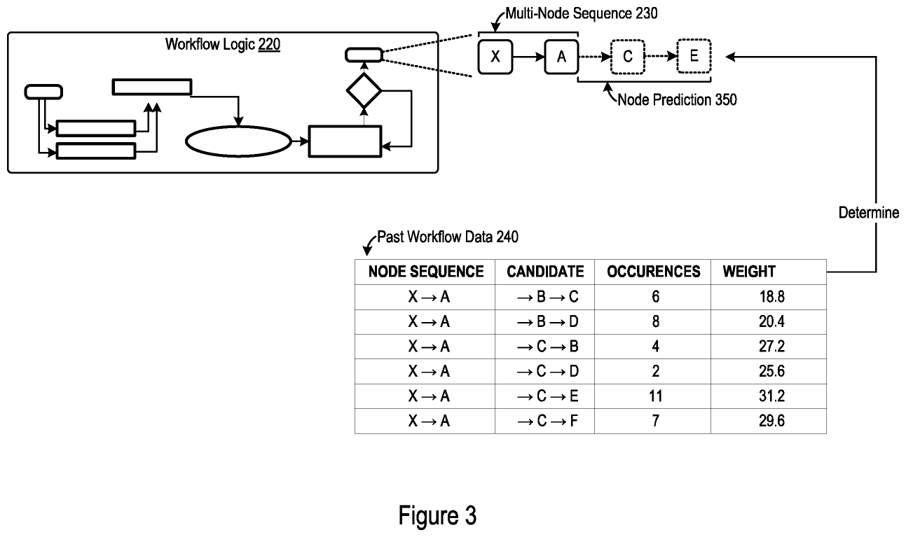

As another feature of the multi-level prediction technology described herein, the logic construction may support multi-node predictions. That is, node predictions determined by the logic construction engine 110 need not be limited to single node predictions, and may instead comprise predicted multiple node sequences. Example features of such are described in greater detail next with reference to FIG. 3.

FIG. 3 shows an example determination of a predicted multiple node sequence for workflow logic. The example in FIG. 3 also includes the workflow logic 220 described in FIG. 2, and the logic construction engine 110 may identify a multi-node sequence for which to determine a node prediction for as the X→A multi-node sequence 230. As shown in FIG. 3, the logic construction engine 110 may determine a node prediction 350 for the X→A multi-node sequence 230, particularly as comprising a predicted multiple node sequence that follows the multi-node sequence 230 inserted into the workflow logic 220.

To determine a node prediction with a predicted multiple node sequence, the logic construction engine 110 may aggregate past workflow data 240 specifically for the multi-node sequence 230 identified from the workflow logic 220. As the logic construction engine 110 may generate a predicted multiple node sequence for the X→A multi-node sequence 230, the logic construction engine 110 may aggregate the past workflow data 240 to identify occurrences of the X→A multi-node sequence in preexisting instances of workflow logic as well as multiple subsequent nodes that follow the occurrences of the X→A multi-node sequence. For a predicted multiple node sequence that is two (2) nodes in length, the logic construction engine 110 may identify candidate predicted node sequences that are two nodes in length. As such, the logic construction engine 110 may aggregate the past workflow data based on occurrences of node sequences that are four (4) nodes deep, comprising the X→A multi-node sequence followed by two subsequent nodes (which, as described herein, may be identified via port-specific connections).

In the example in FIG. 3, the logic construction engine 110 aggregates the past workflow data 240 for the multi-node sequence 230 for which to determine a predicted multiple node sequence. In FIG. 3, the logic construction engine 110 identifies occurrences of various node sequences in preexisting workflow logic instances, particularly six (6) occurrences of an X→A→B→C node sequence, eight (8) occurrences of an X→A→B→D node sequence, four (4) occurrences of an X→A→C→B sequence, two (2) occurrences of an X→A→C→D sequence, eleven (11) occurrences of an X→A→C→E sequence, and seven (7) occurrences of an X→A→C→F sequence. The logic construction engine 110 may then determine a node prediction from the aggregated past workflow data 240.

In some examples, the logic construction engine 110 may determine a node prediction by applying a weighting function to the aggregated past workflow data. Some weighting functions may be configured such that node occurrences further from instances of the multi-node sequence 230 in the aggregated past workflow data are weighted lower than node occurrences closer to instances of the multi-node sequence 230 in the aggregated past workflow data. As one example, the weighting function applied by the logic construction engine 110 may take the following form:

$$Weight Value = {N}_{{c}_{0} \to {c}_{1}} * {F}_{1} + {N}_{{c}_{1} \to {c}_{2}} * {F}_{2} + … + {N}_{{c}_{n - 1} \to {c}_{n}} * {F}_{n}$$

In this example, N may refer to a number of (e.g., port-specific) occurrences of a particular node with a distance of n from the last node of an identified multi-node sequence and F may refer to an applied weight in the weighting function. Thus, F₁ may refer to a first weight applied to a number of occurrences of a given node a distance of one (1) node from the last node of the identified multi-node sequence (e.g., immediately following the multi-node sequence), F₂ may refer to a first weight applied to a number of occurrences of a given node a distance of two (2) nodes from the last node of the identified multi-node sequence, and so forth.

Illustrating through the example in FIG. 3, c₀ may refer to the last node of the multi-node sequence 230 (in this case, node “A”), N_{c}_{₀}_{→c}_{₁} may refer to a number of occurrences of a given node immediately following node “A” in the past workflow data, N_{c}_{₁}_{→c}_{₂} may refer to a number of occurrences of a given node a distance of two (2) nodes from node “A”, and so forth. As seen in the past workflow data 240 in FIG. 3, N_{c}_{₀}_{→c}_{₁} for node “B” occurs fourteen (14) total times in the past workflow data and N_{c}_{₀}_{→c}_{₁} for node “C” occurs twenty-four (24) total times in the past workflow data. Similar aggregation amounts can be determined for occurrences of nodes for N_{c}_{₀}_{→c}_{₁}, and the logic construction engine 110 may assign weights accordingly (e.g., F₁=1.0, F₂=0.8, and so forth). Via such a weighting formula, the logic construction engine 110 may compute weight values for each node sequence and determine, as a node prediction, the node sequence with the greatest weight value.

In FIG. 3, the logic construction engine 110 computes the weight values shown in the past workflow data 240 and determines the node prediction 350 of C→E as a predicted multiple node sequence for the X→A multi-node sequence 230 of the workflow logic 220.

Although one specific example is described herein with reference to FIG. 3, the logic construction engine 110 may apply a weighting function for determination of predicted multiple node sequences in any number of various ways or weights. Weight values may be computed by the logic construction engine 110 based on (e.g., as a function of) the number of connections between a multi-node sequence (identified from the workflow logic 220) and subsequent node occurrences—e.g., as extracted from past workflow data—multiplied by a corresponding weight. The greater the distance (e.g., measured in in connections) from the multi-node sequence for which a prediction is determined, the smaller the weight the logic construction engine 110 may apply in computing the weighting value via the weighting function.

In any of the ways described herein, the logic construction engine 110 may determine multi-level node predictions. The context within workflow logic by which the logic construction engine 110 determines node predictions may be flexible, configurable, or adaptable. That is, the logic construction engine 110 may identify multi-node sequences within workflow logic of any configurable depth (or length) and may likewise determine node predictions in the form of predicted multiple node sequences of any configurable depth (or length). In some implementations, the workflow logic context in which the logic construction engine 110 determines node predictions may be fixed, for example by identifying multi-node sequences inserted into workflow logic that are two (2) nodes in depth and determining node predictions as predicted multiple node sequences that are three (3) nodes in depth.

As another feature, the logic construction engine 110 may determine node predictions within multiple contexts for workflow logic. In that regard, the logic construction engine 110 may determine node predictions for a delineated portion of workflow logic by considering multiple contexts (e.g., multiple identified multi-node sequences of different lengths) and determining multiple node predictions of varying depth. In such examples, the logic construction engine 110 may apply a weighting function to compute weight values for each of the multiple contexts as well as the node predictions of varying length. Then, the logic construction engine 110 may provide any number of determined node predictions as suggested insertions into the workflow logic, e.g., the determined node predictions with the top three (3) weight values. With such multi-context node predictions, the logic construction engine 110 may flexibly determine and provide node predictions of varying length determined in varying contexts, allowing a CAD application user to consider node predictions of various types and depth.

Such expansion of node prediction capabilities may exceed the predetermined limitations of conventional techniques, and provided added configurability and adaptability on workflow logic design. Moreover, multiple context or multiple node predictions of varying length may reduce computational strain on CAD applications, by allowing a user to select a node prediction that best fits a current design step in workflow logic. Such technical features may improve CAD computing systems by reducing execution latencies and increasing user configurability.

As noted herein, the multi-level prediction technology of the present disclosure may provide for capabilities to determine node predictions comprising multiple node sequences. The prediction depth of such multi-level predictions can be near-limitless, and the logic construction engine 110 can generate node predictions numbering tens or hundreds of nodes in length, potentially more. Such multi-level predictions may reduce execution latencies for CAD applications, and can result in significant efficiency increases in workflow logic design. In contrast to single-level predictions which require sequential node predictions and user selections over and over, multi-level predictions provided by the present disclosure may generate node predictions for insertion into workflow logic with significantly less overhead, reduced user interaction, and increased speed. Through such improvements, workflow logic design and CAD computing system efficiency can be improved.

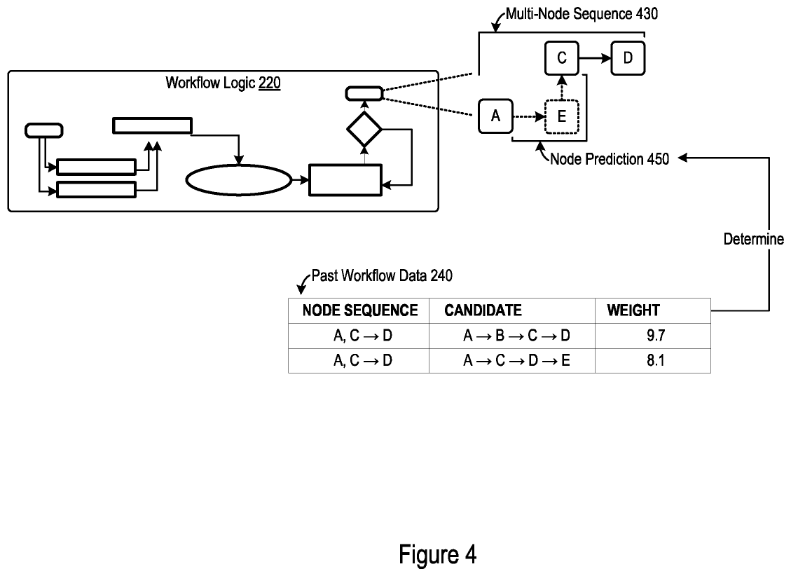

In the examples above, the logic construction engine 110 can generate node predictions for one or more predicted nodes for insertion after (e.g., subsequent to) an identified multi-node sequence. Additionally or alternatively, the multi-level prediction technology of the present disclosure can support splicing of node predictions into workflow logic. In that regard, node predictions determined by the logic construction engine 110 may connect multiple disjointed (e.g., unconnected) nodes in workflow logic. Example features of splicing node predictions that the logic construction engine 110 may determine are described in greater detail next with reference to FIG. 4.

FIG. 4 shows an example determination of a node prediction that connects disjointed nodes inserted into workflow logic. In the example of FIG. 4, the logic construction engine 110 identifies a multi-node sequence 430 inserted into the workflow logic 220 for which to determine a node prediction. The multi-node sequence 430 inserted into the workflow logic 220 may include two disjoint nodes unconnected in the workflow logic 220, and logic construction engine 110 may determine a node prediction 450 as comprising a predicted node to insert into the workflow logic 220 to connect the two disjoint nodes.

In the particular example shown in FIG. 4, the multi-node sequence 430 identified by the logic construction engine 110 includes node “A” and a C→D node sequence. Node “A” may be disjointed from the C→D node sequence in that node “A” no connection exists in the workflow logic 220 that links node “A” to any of nodes “C” or “D” in the C→D node sequence. To determine a node prediction this multi-node sequence 430 shown in FIG. 4, the logic construction engine 110 may aggregate past workflow data 240 for the multi-node sequence 430. As the multi-node sequence 430 includes disjointed nodes, the logic construction engine 110 may parse preexisting instances of workflow logic to identify node sequences that include the nodes of multi-node sequence 430, but not necessarily in direct succession.

In some implementations, the logic construction engine 110 may identify occurrences of node sequences in preexisting workflow logic instances in which intervening nodes exist between the disjointed nodes of the multi-node sequence 430. Such an example is shown as part of the past workflow data 240 in the A→B→C→D node sequence aggregated by the logic construction engine 110. In a consistent manner, the logic construction engine 110 may identify occurrences of node sequences with multiple intervening nodes between the disjointed nodes of the multi-node sequence 430 (e.g., a A→X→Y→Z→C→D sequence, as but one example). Moreover, the logic construction engine 110 may identify occurrences of node sequences that include zero (0) intervening nodes between the disjointed nodes in the multi-node sequence. An example of such is shown in the past workflow data 240 of FIG. 4 as the A→C→D→E sequence. In this example, a candidate node prediction that the logic construction engine 110 may consider comprises a direct connection between the disjointed nodes of the multi-node sequence (in this case, a prediction connection between node “A” and the C→D node sequence of the multi-node sequence 430) as well as a predicted node that follows the multi-node sequence 430 (in this case, node “E” following the C→D node sequence of the multi-node sequence 430).

In determining a node prediction based on aggregated past workflow data 240, the logic construction engine 110 may apply a weighting function to compute weights. Such application of a weighting function may allow the logic construction engine 110 select of a node prediction based on a greatest computed weight value. As another example, the logic construction engine 110 may apply Markov chain-based node prediction determinations, e.g., by determining a node prediction based on a candidate node sequence in the past workflow data 240 with a greatest number of occurrences. In the example of FIG. 4, the logic construction engine determines the node prediction 450 as a predicted node “E” that connects node “A” of the multi-node sequence 430 to the C→D node sequence of the multi-node sequence 430. Accordingly, the node prediction determined by the logic construction engine 110 may be spliced into multiple disjoint nodes inserted into the workflow logic 220.

Node prediction splicing performed by the logic construction engine 110 may be split into multiple parts. As an illustrative example, the logic construction engine 110 may identify a multi-node sequence that comprises standalone nodes “A” and “C”. In such an example, the logic construction engine 110 determine a multi-level node prediction from node “A” as the node sequence A→B→C→D, in which nodes “B” and “D” are determined as node predictions to splice into the workflow logic 220. As noted herein, depending on the workflow logic 220, the logic construction engine 110 may determine node predictions that without any prediction node insertion, and only comprising insertion of connections to one or more of the disjointed nodes in an identified multi-node sequence in workflow logic for which to generate a node prediction.

Many example features of multi-level prediction technology according to the present disclosure are disclosed herein. The logic construction engine 110 may implement any combination of any of the features described herein, and may thereby improve the efficiency, flexibility, and prediction accuracy of workflow logic design processes and CAD applications.

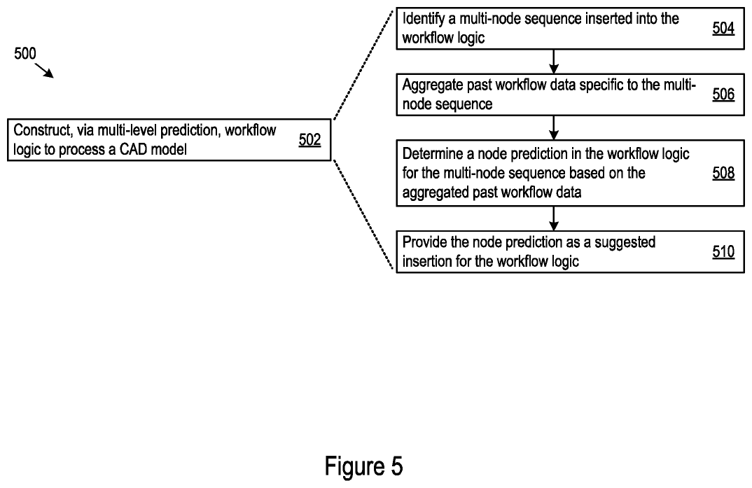

FIG. 5 shows an example of logic 500 that a system may implement to support multi-level predictions in workflow logic of CAD applications. For example, the computing system 100 may implement the logic 500 as hardware, executable instructions stored on a machine-readable medium, or as a combination of both. The computing system 100 may implement the logic 500 via the logic construction engine 110, through which the computing system 100 may perform or execute the logic 500 as a method to provide any combination of the multi-level prediction features presented herein. The following description of the logic 500 is provided using the logic construction engine 110 as an example. However, various other implementation options by computing systems are possible.

In implementing the logic 500, the logic construction engine 110 may construct, via multi-level prediction, workflow logic to process a CAD model (502). The logic construction engine 110 may do so identifying a multi-node sequence inserted into the workflow logic (504), aggregating past workflow data specific to the multi-node sequence (506), determining a node prediction in the workflow logic for the multi-node sequence based on the aggregated past workflow data (508), and providing the node prediction as a suggested insertion for the workflow logic (510).

The logic construction engine 110 may provide the node prediction as a suggested insertion in various ways. For example, the logic construction engine 110 may present the node prediction in a user interface, allowing a user to confirm the provided node prediction. Responsive to such a confirmation, the logic construction engine 110 may insert the determined node prediction into the workflow logic. In some implementations, the logic construction engine 110 may provide multiple different node predictions (e.g., ranked order based on computed weight values, Markov chain probabilities, number of occurrences, or any other suitable metric), allowing a user to flexibly select one (or none) of the provided node predictions for insertion into the workflow logic.

The logic 500 shown in FIG. 5 provides an illustrative example by which a computing system 100 may support multi-level predictions in workflow logic for CAD applications according to the present disclosure. Additional or alternative steps in the logic 500 are contemplated herein, including according to any of the various features described herein for the logic construction engine 110.

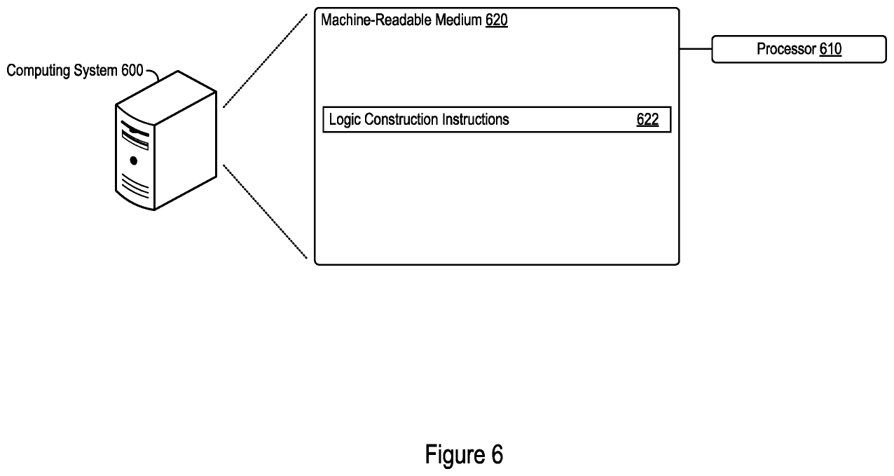

FIG. 6 shows an example of a computing system 600 that supports multi-level predictions in workflow logic of CAD applications. The computing system 600 may include a processor 610, which may take the form of a single or multiple processors. The processor(s) 610 may include a central processing unit (CPU), microprocessor, or any hardware device suitable for executing instructions stored on a machine-readable medium. The computing system 600 may include a machine-readable medium 620. The machine-readable medium 620 may take the form of any non-transitory electronic, magnetic, optical, or other physical storage device that stores executable instructions, such as the logic construction instructions 622 shown in FIG. 6. As such, the machine-readable medium 620 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 600 may execute instructions stored on the machine-readable medium 620 through the processor 610. Executing the instructions (e.g., the logic construction instructions 622) may cause the computing system 600 to perform any aspect of the multi-level prediction technology described herein, including according to any of the features the logic construction engine 110.

For example, execution of the logic construction instructions 622 by the processor 610 may cause the computing system 600 to construct, via multi-level prediction, workflow logic to process a CAD model. The logic construction instructions 622 may cause the computing system 600 to do so by identifying a multi-node sequence inserted into the workflow logic, aggregating past workflow data specific to the multi-node sequence, determining a node prediction in the workflow logic for the multi-node sequence based on the aggregated past workflow data, and providing the node prediction as a suggested insertion for the workflow logic.

Any additional or alternative multi-level prediction features as described herein may be implemented via the logic construction instructions 622.

The systems, methods, devices, and logic described above, including the logic construction engine 110, may be implemented in many different ways in many different combinations of hardware, logic, circuitry, and executable instructions stored on a machine-readable medium. For example, the logic construction engine 110 may include or other implement circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the logic construction engine 110.

The processing capability of the systems, devices, and engines described herein, including the logic construction engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
constructing, via multi-level prediction, workflow logic to process a computer-aided design model, wherein constructing the workflow logic via the multi-level prediction comprises:
identifying a multi-node sequence inserted into the workflow logic;
aggregating past workflow data specific to the multi-node sequence;
determining a node prediction in the workflow logic for the multi-node sequence based on the aggregated past workflow data; and
providing the node prediction as a suggested insertion for the workflow logic.

2. The method of claim 1, wherein aggregating the past workflow data specific to the multi-node sequence comprises:
accessing past workflow data that comprises the multi-node sequence; and
filtering the past workflow data that comprises the multi-node sequence specifically for a particular user, a particular user role, a specific application client used to construct the workflow logic, a particular CAD model type, or any combination thereof.

3. The method of claim 1, wherein the node prediction comprises a predicted multiple node sequence that follows the multi-node sequence inserted into the workflow logic.

4. The method of claim 1, wherein the multi-node sequence inserted into the workflow logic comprises two disjoint nodes unconnected in the workflow logic, and comprising determining the node prediction as comprising a predicted node to insert into the workflow logic to connect the two disjoint nodes.

5. The method of claim 1, comprising determining the node prediction by applying a weighting function to the aggregated past workflow data in which node occurrences further from instances of the multi-node sequence in the aggregated past workflow data are weighted lower than node occurrences closer to instances of the multi-node sequence in the aggregated past workflow data.

6. The method of claim 1, wherein aggregating the past workflow data specific to the multi-node sequence comprises filtering past workflow data that comprises the multi-node sequence specifically for particular port connections used to connect the multi-node sequence.

7. The method of claim 1, wherein identifying the multi-node sequence comprises selecting nodes in the workflow logic of a fixed length prior to a prediction point in the workflow logic.

8. A system comprising:
a processor; and
a non-transitory machine-readable medium that, when executed by the processor, causes a computing system to construct, via multi-level prediction, workflow logic to process a computer-aided design model, including by:
identifying a multi-node sequence inserted into the workflow logic;
aggregating past workflow data specific to the multi-node sequence;
determining a node prediction in the workflow logic for the multi-node sequence based on the aggregated past workflow data; and
providing the node prediction as a suggested insertion for the workflow logic.

9. The system of claim 9, wherein the instructions, when executed, cause the computing system to aggregate the past workflow data specific to the multi-node sequence by:
accessing past workflow data that comprises the multi-node sequence; and
filtering the past workflow data that comprises the multi-node sequence specifically for a particular user, a particular user role, a specific application client used to construct the workflow logic, a particular CAD model type, or any combination thereof.

10. The system of claim 8, wherein the node prediction comprises a predicted multiple node sequence that follows the multi-node sequence inserted into the workflow logic.

11. The system of claim 8, wherein the multi-node sequence inserted into the workflow logic comprises two disjoint nodes unconnected in the workflow logic, and wherein the instructions, when executed, cause the computing system to determine the node prediction as comprising a predicted node to insert into the workflow logic to connect the two disjoint nodes.

12. The system of claim 8, wherein the instructions, when executed, cause the computing system to determine the node prediction by applying a weighting function to the aggregated past workflow data in which node occurrences further from instances of the multi-node sequence in the aggregated past workflow data are weighted lower than node occurrences closer to instances of the multi-node sequence in the aggregated past workflow data.

13. The system of claim 8, wherein the instructions, when executed, cause the computing system to aggregate the past workflow data specific to the multi-node sequence by filtering past workflow data that comprises the multi-node sequence specifically for particular port connections used to connect the multi-node sequence.

14. The system of claim 8, wherein the instructions, when executed, cause the computing system to identify the multi-node sequence by selecting nodes in the workflow logic of a fixed length prior to a prediction point in the workflow logic.

15. A non-transitory machine-readable medium comprising instructions that, when executed by a processor, cause a computing system to construct, via multi-level prediction, workflow logic to process a computer-aided design model, including by:
identifying a multi-node sequence inserted into the workflow logic;
aggregating past workflow data specific to the multi-node sequence;
determining a node prediction in the workflow logic for the multi-node sequence based on the aggregated past workflow data; and
providing the node prediction as a suggested insertion for the workflow logic.

16. The non-transitory machine-readable medium of claim 15, wherein the instructions, when executed, cause the computing system to aggregate the past workflow data specific to the multi-node sequence by:
accessing past workflow data that comprises the multi-node sequence; and
filtering the past workflow data (240) that comprises the multi-node sequence specifically for a particular user, a particular user role, a specific application client used to construct the workflow logic, a particular CAD model type, or any combination thereof.

17. The non-transitory machine-readable medium of claim 15, wherein the multi-node sequence inserted into the workflow logic comprises two disjoint nodes unconnected in the workflow logic, and wherein the instructions, when executed, cause the computing system to determine the node prediction as comprising a predicted node to insert into the workflow logic to connect the two disjoint nodes.

18. The non-transitory machine-readable medium of claim 15, wherein the instructions, when executed, cause the computing system to determine the node prediction by applying a weighting function to the aggregated past workflow data in which node occurrences further from instances of the multi-node sequence in the aggregated past workflow data are weighted lower than node occurrences closer to instances of the multi-node sequence in the aggregated past workflow data.

19. The non-transitory machine-readable medium of claim 15, wherein the instructions, when executed, cause the computing system to aggregate the past workflow data specific to the multi-node sequence by filtering past workflow data that comprises the multi-node sequence specifically for particular port connections used to connect the multi-node sequence.

20. The non-transitory machine-readable medium of claim 15, wherein the instructions, when executed, cause the computing system to identify the multi-node sequence by selecting nodes in the workflow logic of a fixed length prior to a prediction point in the workflow logic.
